(19) United States
(12) Patent Application Publication
(10) Pub. No.: US 2008/0145610 A1
(43) Pub. Date: Jun. 19, 2008

(54) Protective Coating and Method for the Production Thereof

(76) Inventors: Claus-Michael Muller, Essen (DE); Eugen Kleen, Schermbeck (DE); Thomas Schmitz, Hahnheim (DE); Ulrich Bensing, Alfeld/Leine (DE); Horst Schillert, Grunenplan (DE); Roland Huttl, Berlin (DE); Bernd Hillemeier, Berlin (DE)

Correspondence Address: BLAKELY SOKOLOFF TAYLOR & ZAFMAN, 1279 OAKMEAD PARKWAY, SUNNYVALE, CA, 94085-4040, US

(21) Appl. No.: 11/661,580

(22) PCT Filed: Aug. 25, 2005
(86) PCT No.: PCT/EP05/09179

§ 371 Date: Nov. 14, 2007

(30) Foreign Application Priority Data
Sep. 1, 2004 (EP) 04020759.9

(51) Int. Cl. B32B 17/06; B32B 13/04; E04F 13/14; B29C 63/02

(52) U.S. Cl. 428/142; 156/325; 428/335; 428/331; 427/140; 427/230; 428/294.7

(57) ABSTRACT

The invention relates to a protective coating for a mechanically stabile, in particular mineral and/or metallic base, comprising an inorganic polysilicate-cohesion adhesive layer which is uniformly distributed, essentially, on the base. A coating made of a glass film material having a thickness of less than 2 mm, preferably, less than 0.3 mm, is applied to the polysilicate cohesion adhesive layer prior to the hardening thereof, which covers the polysilicate-cohesion adhesive layer. According to the method for producing the protective coating, initially, the inorganic polysilicate-cohesion adhesive and the glass film material are prepared, then the cohesion adhesive is applied to the base which is to be coated and/or one side of the glass film material, and the glass film material is applied to the base which is to be coated prior to hardening of the polysilicate-cohesion adhesion layer, such that the glass film material covers the cohesion adhesion layer. Subsequently, the cohesion adhesion layer is hardened.

The invention relates to a protective coating for a mechanically stable, particularly mineral and/or metallic, substrate and a method for producing such a coating. It is known from the Prior Art to provide surfaces of structures, particularly concrete surfaces or surfaces of steel concrete components in the wall, ceiling and floor region of sewage installations, with coatings which improve the resistance to acids and alkalis and have a high mechanical strength. The building mixtures used for such coatings are produced, for instance, from an alkali silicate bonding agent component and a powder component, the powder component containing latent hydraulic substances and silicon dioxide as crucial components.

It is also known in the Prior Art to secure preformed, thick and rigid elements of glass with the aid of plastic adhesives or plastic-modified cement adhesives to concrete surfaces. Concrete surfaces lined in this manner have joints as do surfaces lined with tiles so that the resistance and water tightness of such a building material coating is determined primarily by the joint characteristics. Furthermore, the adhesion of the glass elements secured to the substrate by adhesive is in part not sufficient because the adhesive bond between glass/adhesive/substrate is determined only by adhesion forces because no chemical bonds are formed between glass and adhesive and between adhesive and substrate. Finally, the use of the plastic adhesive or the plastic modified adhesive requires a degree of dryness of the substrate of less than 4% moisture. This is frequently only obtainable at very high expense.

It is, therefore, the object of the invention to provide a building material coating for a mechanically stable substrate and a method of producing it which has a high degree of chemical resistance, particularly acid- and alkali-resistance and is simple to manufacture.

This object is solved in accordance with the invention by a method of producing a protective coating on a mechanically stable, particularly mineral and/or metallic substrate with the features of claim 1 and a protective coating with the features of claim 19.

In accordance with the invention, an inorganic polysilicate cohesion adhesive and a glass film material with a thickness smaller than 2 mm, preferably 0.3 mm, are provided. The polysilicate cohesion adhesive is then applied to the substrate to be coated and/or to one side of the glass film material. The glass film material is then, but before the setting of the polysilicate cohesion adhesive, placed on the substrate to be coated such that the glass film material covers the polysilicate cohesion adhesive and thereafter the polysilicate cohesion adhesive is permitted to set to connect the glass film material to the substrate to be coated. The term mineral substrate is to be understood here as a substrate common in buildings, which includes concrete, brickwork, mineral building materials of all types, bricks, glass and the like, whereby the surface can also be partially of a metallic nature, for instance if steel elements constitute portions of the surface (for instance, with steel concrete substrate). The term metallic substrate is to be understood here as a substrate to which, particularly by reason of an oxide/hydroxide oxide layer forming on the metal, the polysilicate cohesion adhesive adheres by cohesion, ie forms chemical bonds.

The invention starts from the basic recognition that glass films of the stated thickness are flexible or supple such that even lining curved substrates is possible. Furthermore, such thin glass films fit closely against a substrate coated with the polysilicate cohesion adhesive so that contact is produced not only between the substrate and the polysilicate cohesion adhesive but also between the adhesive and the glass layer. Of importance, also, is that the polysilicate cohesion adhesive forms chemical bonds not only with the mineral substrate but also with the glass lining so that a mechanically virtually inseparable “monolithic-silicate bonding system” is produced. This bonding system, consisting of substrate, polysilicate cohesion adhesive and glass is also highly temperature resistant since no organic adhesive is used. The surface constituted by the glass affords the high resistance, which is typical for glass, to chemicals, particularly acids and alkalis. The seal of the protective coating to aggressive media exceeds the extent achievable with known coating systems. The surface of the coating has all the advantages of glass surfaces; it is aseptic and free of eluation. It has additionally been determined that the bonding system also exhibits a very powerful adhesion to metallic substrates (eg steel). The polysilicate adhesive, acting as an “adhesion promoter” between the steel and glass layer, additionally exerts a passivating effect on the steel and reduces stresses between the glass and steel. The protective coating also has the advantage that it is simple to repair, for which purpose the same components are used as in its manufacture: after cleaning the surface, the polysilicate cohesion adhesive is applied to the surface to be repaired and/or to the one side of the flexible glass film material and the flexible glass film material is then placed in position.

The polysilicate cohesion adhesive is preferably applied to the substrate to be coated and/or to the one side of the glass film material in a uniform distribution. The application of the polysilicate cohesion adhesive can be effected in parallel strips or in a punctiform or strip matrix; under certain circumstances, the adhesive strips, beads or dots run into the adjacent adhesive regions and constitute a substantially continuous adhesive layer when the glass film material is positioned spread on it and/or pressed against it.

It is provided in a preferred embodiment that the entire area of the substrate to be coated and/or of the one side of the glass film material is coated with the polysilicate cohesion adhesive before the glass film material is positioned on the substrate to be coated.

The application of the polysilicate cohesion adhesive on one side of the glass film material can be advantageous if the glass film material is to be positioned in a mechanised manner, for instance whilst withdrawing it from a roll of material, and is provided with the liquid or pasty polysilicate cohesion adhesive immediately before application.

As a result of their small thickness, the glass films can be positioned in the form of overlapping web or plates, as is provided in a preferred embodiment. In the preferred embodiment, the glass film webs or plates overlap in a narrow region with a width between 0.3 cm and 7 cm, preferably between 2 and 5 cm. In the overlap region, the glass film webs or plates are either welded together (eg autogenously or with the aid of a glass solder) or a polysilicate cohesive adhesive layer is again applied between the overlapping sections of the glass films. A substantially unitary, smooth and chemical-resistant glass surface, which is very impervious due to its absence of joints, is thus produced, which is easy to clean and to disinfect. The surface to be protected can be subjected again to operational or environmental conditions, that is to say, put under load, only a few hours after the application of the protective coating in accordance with the invention since there are no joints and the glass supports the polysilicate cohesion adhesive situated beneath it so that the latter can subsequently set completely “undisturbed”.

Surprisingly, it has transpired that the glass may be highly mechanically loaded as a result of the monolithic bonding system, comprising glass/polysilicate/substrate which is produced despite its small thickness. Thus it has been found that under extreme mechanical pressure or impact stresses, the glass exhibits cracks which form in the contact zone between the polysilicate and glass (ie at the underside of the glass layer) but do not reach the surface of the glass. Surprisingly, a self-healing process of the glass in the composite with the polysilicate cohesion adhesive in the event of such damage of the glass has been discovered: cracks on the underside of the glass heal. This is based presumably on an increased tendency to creep of the polysilicate cohesion adhesive such that stresses in the glass are attenuated. By comparison with conventional plastic coatings, the coating in accordance with convention also has the advantage that in the event of a water pressure acting at the base, defects cannot grow as a result of “cold flow” into bulges. The glass does not creep but remains undeformed at a defect and does not peel away. An inorganic polysilicate cohesion adhesive is preferably prepared by mixing an alkali silicate bonding agent component with a silicon dioxide-containing alumino silicate powder component in the presence of water so that a pasty or liquid composition is produced. The powder component preferably includes between 5 and 50% wt. of at least one pozzuolanic or latent hydraulic component and between 10 and 40% wt. of at least one activated silicon dioxide component. Fly ash, electro filterash, natural pozzuolana, trass, fired oil shale and/or ground blast furnace slag (foundry sand), for instance, can be used as the pozzuolanic or latent hydraulic component. Pyrogenic silica, precipitated silica, silica dust, glass flower and/or fly ash or electro filter ash with a high silica dioxide content, for instance, can be used as the silicon dioxide component. When using a fly ash, this generally constitutes part of both the pozzuolanic component and also of the silicon dioxide component.

In one embodiment, the powder component can additionally include between 5 and 30% wt. of at least one activated oxy aluminium component, the activated aluminium oxy component preferably including aluminium oxide, hydroxide and/or silicate.

In a preferred embodiment, the powder component additionally includes 1 to 10% wt. of a hydraulic bonding agent, preferably alumina cement.

The alkali silicate bonding agent component is preferably an aqueous alkali silicate solution (for instance, soda waterglass or potassium waterglass), which is mixed with the powder component. Preferably, an alkali silicate solution with a solid material content of 40 to 50% wt. is used and the powder component is mixed with 5 to 50% wt., preferably 10 to 15% wt., alkali silicate solution. Alternatively, a pulverulent alkali silicate bonding agent component can be provided, which is initially mixed with the powder component. The pasty or liquid composition is then produced by mixing water into the mixture.

In one embodiment of the method in accordance with the invention, the glass film material consists of a borosilicate glass with 2 to 12%, preferably with 5 to 10%, boron content. This increases the chemical resistance and the thermal load-bearing ability.

The glass films are, for instance, produced by means of a float process. The glass films are preferably so produced by a drawing process that the glass films are of low stress, the term “low stress” also including absence of stress. The surface is, for instance, fire polished.

The coating in accordance with the invention renders different types of coloration of the layer components possible. Firstly, the polysilicate adhesive layer can be coloured by the addition of pigments whereby self-coloration of the components referred to above of the powder component can be reduced by using colourless or white components (for instance, by the preferred addition of aluminium oxy components). The glass films which are used can also be coloured.

Further advantageous and/or preferred embodiments are characterised in the dependent claims.

The invention will be explained in more detail below by way of a preferred embodiment illustrated in the drawings which show as follows:

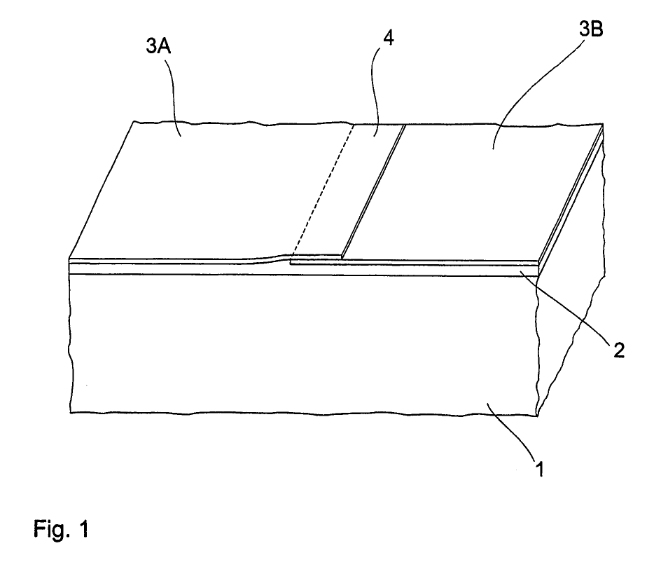

FIG. 1: A schematic view of the layer structure in accordance with the invention and the arrangement of the applied glass film webs or plates.

FIG. 1 shows the coating in accordance with the invention on a mechanically stable, mineral and/or metallic substrate 1. The substrate 1 can be any desired surface of a building. It is preferably a surface consisting of concrete or steel concrete and subjected to increased chemical loading. It is, for instance, the concrete surface or the surface of steel concrete components in wall regions and ceiling regions of sewage installations, for instance of sludge basins, lidded bio-aeration basins, pump shafts and the like. A further advantageous usage of the coating in accordance with the invention resides in the lining of drinking water containers and reservoirs. A series of applications in the chemical industry are also possible. The coating can also be used for lining chimneys or flues (wet-stack application) in order to protect them from sooting up.

The surface of the substrate 1 is firstly coated with a layer 2 of an inorganic polysilicate cohesion adhesive. Before the application of the cohesion adhesive, the substrate is pre-treated, ie cleamed and freed of loose particles, dust, oil or other substances with a release effect. The inorganic polysilicate cohesion adhesive is prepared by mixing a liquid alkali silicate bonding agent component thoroughly with a silicon dioxide-containing alumina-silicate powder component. The powder component contains between 5 and 50% wt of at least one pozzuolanic or latent hydraulic component and between 10 and 40% wt. of at least one activated silicon dioxide component. The pozzuolanic or latent hydraulic component is, in particular, fly ash, electro filter ash, natural pozzuolana, trass, burnt oil shale and/or ground blast furnace slag (foundry sand). The activated silicon dioxide component consists of pyrogenic silica, precipitated silica, silica dust, glass dust and/or fly ash or electro filter ash with a high content of silicon dioxide. The powder component can also include between 5 and 30% wt. of at least one activated aluminium oxy component, whereby this component can partially replace one or more of the latent hydraulic and pozzuolanic components. Calcinated bauxite or the minerals hydragillite, gibbsite, böhmite, diaspore, alumogel or sporogillite or so-called active alumina can be used as the aluminium oxy component. The powder component preferably additionally includes between 1 and 10% wt. of a hydraulic bonding agent, particularly alumina cement. The powder component further includes inert components, such as 40-60% wt. quartz sand and further additives, such as redispersible polymer bonding agent, shrinkage reducer, fibres and pigments. For instance, an acid-resistant two-component polymer silicate on a mineral basis, as is offered by the company MC-Bauchemie, can be used as the polysilicate cohesion adhesive.

A preferred formulation for the powder component of the cohesion adhesive includes:
10-30% wt. fly ash
1-10% wt. further latent hydraulic material
10-30% wt. pyrogenic silica
1-10% wt. alumina cement
40-60% wt. quartz sand
1-5% wt pigments
1-3% wt shrinkage reducer
1-5% wt redispersible polymer bonding agent
0.05-2% wt. fibres.

For the alkaline silicate bonding agent component, a potassium water glass solution with a solid material content of 40-50% is preferably used and with a mola ratio of SiO₂:K₂O of less than 2.3:1, preferably between 1.5:1 and 0.8:1. The potassium waterglass solution is added to the powder component directly before use in an amount of between 5 and 30% wt., preferably between 12 and 15% wt.

The prepared polysilicate cohesion adhesive is subsequently applied by painting, rolling or spreading on to the substrate 1.

After the application of the polysilicate cohesion adhesive layer 2, it is covered with glass film webs or plates 3A, 3B with a thickness smaller than 2 mm, preferably smaller than 0.3 mm, such that the adhesive layer is covered and the glass film webs or plates 3A, 3B slightly overlap with one another. In the overlap region 4, the glass films are welded autogenously with the aid of a glass solder or, preferably, secured by adhesive with the aid of the polysilicate cohesion adhesive. The thin glass films can consist of lime soda glass, alkali-free glasses, or glass ceramic. The glass films preferably consist of borosilicate glass with a boron content about 5-10%. For instance, glass film webs or plates of glasses of type D 263 S or type AF 45 from the company Schott AG are used.

After the application of the polysilicate cohesion adhesive layer, the glass film webs or plates are positioned, preferably within a processing time of up to 40 minutes.

The size of the glass film webs or plates used depends primarily on the thickness of the glass films and on the maximum curvature of the substrate and on whether the substrate is curved in one or two mutually perpendicular directions. Smaller glass film plates are laid in regions with complicated curvature conditions than on substrates which are flat or curved in only one direction. The dimensions and the geometry of the glass film plates are preferably matched to the geometry of the surface of the substrate. For instance, square, rectangular, triangular, strip-shaped and/or circular segmental plates are provided.

The glass film plates are initially cut to size and applied in a pre-determined size and/or cut in situ.

1. A method of producing a protective coating on a mechanically stable substrate, the method comprising the steps of:
(a) applying a polysilicate cohesion adhesive to at least one of the substrate and one side of a glass film material, the glass film material having a thickness smaller than 2 mm;
(b) applying the glass film material to the substrate such that the glass film material covers the applied polysilicate cohesion adhesive;
(c) setting polysilicate cohesion adhesive to connect the glass film material to the substrate.

2. A method as claimed in claim 1, wherein said applying the polysilicate cohesion adhesive to at least one of the substrate and the one side of the glass film material is in a uniform distribution.

3. A method as claimed in claim 2, wherein at least one of the substrate and one side of the glass film material surface is entirely coated with the polysilicate cohesion adhesive before the glass film material is applied to the substrate.

4. A method as claimed in claim 3, wherein the inorganic polysilicate cohesion adhesive is prepared by mixing an alkali silicate bonding agent component with a silicon dioxide-containing, alumo silicate powder component in the presence of water so that a pasty or liquid composition is produced.

5. A method as claimed in claim 4, wherein the powder component contains between 5 and 50% wt. of at least one pozzuolanic or latent hydraulic component and between 10 and 40% wt. of at least one activated silicon dioxide component.

6. A method as claimed in claim 5, wherein at least one pozzuolanic or latent hydraulic component is selected from a first group of substances, which includes fly ash, electrofilter ash, natural pozzuolana, trass, burnt oil shale and ground blast furnace slag (foundry sand), and that at least one activated silicon dioxide component is selected from a second group of substances, which includes pyrogenic silica, precipitated silica, silica dust, glass flour and fly ash or electrofilter ash with a high silicon dioxide content.

7. A method as claimed in claim 5, wherein the powder component further includes between 5 and 30% wt. of at least one activated aluminium oxy component.

8. A method as claimed in claim 7, wherein the least one activated aluminium oxy component includes an aluminium oxide, hydroxide and/or silicate.

9. A method as claimed in claim 5, wherein the powder component additionally contains 1-10% wt. of a hydraulic bonding agent.

10. A method as claimed in claim 4, wherein an aqueous alkali silicate solution is provided as the alkali silicate bonding agent component, which is mixed with the powder component.

11. A method as claimed in claim 10, wherein an alkali silicate solution with a solid material content of 40 to 50% is used and that the powder component is mixed with 5-10% wt.

12. A method as claimed in claim 4, further comprising mixing a pulverulent alkali silicate bonding agent component with the powder component and mixing water into the mixture of the pulverulent alkali silicate bonding agent and the powder component to produce the pasty or liquid composition.

13. A method as claimed in claim 4, further comprising adding a powder component which contains 40 to 60% wt. of an inert component.

14. A method as claimed in claim 1, wherein the glass film material is in the form of webs or plates, which are positioned so as to overlap another.

15. A method as claimed in claim 14, wherein the glass film webs or plates overlap in a narrow region with a breadth between 0.3 cm and 7 cm.

16. A method as claimed in claim 1, wherein the glass film material comprises a borosilicate glass with a boron content of 2 to 12.

17. A method as claimed in claim 1, wherein the glass film material is produced in a low-stress manner by drawing process.

18. A method as claimed in claim 1, wherein the glass film material is produced in a low-stress manner by a float process.

19. A protective coating for a mechanically stable substrate, comprising:
an inorganic polysilicate cohesion adhesive layer having a substantially uniform distribution on the substrate and
a coating of glass film material positioned on the polysilicate cohesion adhesive layer before the setting thereof, with a thickness smaller than 2 mm, which covers the polysilicate cohesion adhesive layer.

20. A coating as claimed in claim 19, wherein the polysilicate cohesion adhesive layer is arranged over the entire area between the substrate and the lining of glass film material.

21. A coating as claimed in claim 19, wherein the inorganic polysilicate cohesion adhesive layer contains an alkali silicate bonding agent component and a silicon dioxide containing, alumino silicate powder component.

22. A coating as claimed in claim 21, wherein the powder component includes between 5 and 50% wt. of at least one pozzuolanic or latent hydraulic component and between 10 and 40% wt. of at least one activated silicon dioxide component.

23. A coating as claimed in claim 22, wherein at least one pozzuolanic or latent hydraulic component is selected from a further group of substances, which includes fly ash, natural pozzuolana, trass, burnt oil shale and ground blast furnace slag (foundry sand), and that at least one activated silicon dioxide component is selected from a second group of substances, which includes pyrogenic silica, precipitated silica, silica dust, glass flour and fly ash or electrofilter ash with a high silicon dioxide content.

24. A coating as claimed in claim 22, wherein the powder component includes between 5 and 30% wt. of at least one activated aluminium oxy component.

25. A coating as claimed in claim 24, wherein the least one activated aluminium oxy component includes an aluminium oxide, aluminium hydroxide and/aluminium silicate.

26. A coating as claimed in claim 19, wherein the powder component additionally includes between 1 and 10% wt. of a hydraulic bonding agent.

27. A coating as claimed in claim 19, wherein the alkali silicate bonding agent component is an alkali water glass.

28. A coating as claimed in claim 22, wherein the powder component includes between 40 and 60% wt. of an inert component.

29. A coating as claimed in claim 22, wherein the powder component includes at least one additive from a group of additives, the group of additives including redispersible polymer bonding agent, reducer, fibres and pigments.

30. A coating as claimed in claim 19, wherein the glass films are glass film webs or plates positioned next to one another and overlapping one another.

31. A coating as claimed in claim 30, wherein the glass film webs or plates overlap in a narrow region with a breadth between 0.3 cm and 7 cm.

32. A coating as claimed in claim 30, wherein the glass film webs or plates are welded together or secured by adhesive with the polysilicate cohesion adhesive in the overlap region.

33. A coating as claimed in claim 20, wherein the glass film webs or plates consist of a borosilicate glass, with a boron content of 2 to 12%.

34. A method comprising: lining wall and ceiling regions of sewage installations with a coating as defined in claim 19.

35. A method of using a coating as claimed in claim 19 to protect a chimney against sooting up, the method comprising: lining the chimney with the coating.

36. A method of using a coating as claimed in claim 19, the method comprising: lining drinking water containers and reservoirs with the coating.

37. A method of using a coating as claimed in claim 19, the method comprising: repairing damaged or defective areas in a mechanically stable, particularly mineral and/or metallic, substrate with the coating.
